(19) United States
(12) Patent Application Publication
(10) Pub. No.: US 2019/0267859 A1
(43) Pub. Date: Aug. 29, 2019

(54) ROTARY ELECTRIC MACHINE ROTOR AND ROTARY ELECTRIC MACHINE

(71) Applicant: HONDA MOTOR CO., LTD., Tokyo (JP)

(72) Inventor: Takashi Kitahara, Wako-shi (JP)

(21) Appl. No.: 16/274,373

(22) Filed: Feb. 13, 2019

(30) Foreign Application Priority Data
Feb. 27, 2018 (JP) 2018-033406

(51) Int. Cl. H02K 1/32; H02K 1/27

(52) U.S. Cl. CPC H02K 1/32; H02K 1/276

(57) ABSTRACT

A rotary electric machine rotor includes a rotor core and a permanent magnet. The rotor core includes a core main body block, a passage block, and a cooling pipe. The permanent magnet is bonded and fixed to the core main body block. The passage block has a coolant passage connected to a coolant introduction passage of a rotation shaft and is joined to an end part in an axial direction of the core main body block. The cooling pipe is connected to the coolant passage of the passage block and is arranged along an axial direction in the vicinity of the permanent magnet of the core main body block.

### CROSS-REFERENCE TO RELATED APPLICATION

Priority is claimed on Japanese Patent Application No. 2018-033406, filed on Feb. 27, 2018, the contents of which are incorporated herein by reference.

### BACKGROUND

### Field of the Invention

The present invention relates to a rotary electric machine rotor that performs cooling by a coolant and a rotary electric machine that uses the rotor.

### Background

As a rotary electric machine that is mounted on a vehicle and the like, such a machine is known which includes a rotor that is rotated integrally with a rotation shaft and a stator that is arranged on an outer side in a radial direction of the rotor and in which a plurality of permanent magnets are arranged on an outer circumference of the rotor, and a coil is wound around the stator. In this type of rotary electric machine, during the operation, the permanent magnet of the rotor and the coil part of the stator easily generate heat.

As a countermeasure against this, a rotary electric machine that cools a rotor and a coil part of a stator by a coolant is known (for example, refer to Japanese Patent Application, Publication No. 2011-223803A, Japanese Patent Application, Publication No. 2016-86462A, and Japanese Patent Application, Publication No. 2016-54608A).

In the rotary electric machine of the related art described above, the rotor is formed of a laminate steel plate and the like, a passage hole through which a coolant passes is formed on the laminated steel plate, and a permanent magnet is fixed by a bond to the laminate steel plate in a state of being fitted to an attachment hole of the laminated steel plate.

### SUMMARY

However, in the rotor of the rotary electric machine of the related art described above, since the passage hole of the coolant is formed on the laminate steel plate, and the permanent magnet is fixed by the bond to the laminate steel plate, there is a concern that, at the time of manufacturing, the bond for fixing the permanent magnet flows into the passage hole, and the passage cross-sectional area of the passage hole is narrowed. When the passage cross-sectional area of the passage hole is narrowed, the flow of the coolant becomes unstable, and it becomes difficult to obtain a stable cooling performance.

An aspect of the present invention provides a rotary electric machine rotor and a rotary electric machine that are capable of preventing a bond for fixing a permanent magnet to a rotor from narrowing a passage of a coolant at the time of manufacturing and that are capable of obtaining a stable cooling performance of the rotor.

A rotary electric machine rotor according to an aspect of the present invention is a rotor of a rotary electric machine which includes: a rotor core that is fixed to a rotation shaft and that is rotated integrally with the rotation shaft; and a permanent magnet that is bonded and fixed to the rotor core, wherein a coolant that is introduced from a coolant introduction passage of the rotation shaft flows in a vicinity of the permanent magnet of the rotor core and cools the rotor core, wherein the rotor core includes: a core main body block to which the permanent magnet is bonded and fixed; a passage block that has a coolant passage which is connected to the coolant introduction passage of the rotation shaft and that is joined to an end part in an axial direction of the core main body block; and a cooling pipe that is connected to the coolant passage of the passage block and that is arranged along an axial direction in a vicinity of the permanent magnet of the core main body block.

According to the above configuration, when the coolant is supplied to the coolant passage of the passage block via the coolant introduction passage of the rotation shaft, the coolant flows in the cooling pipe that is connected to the coolant passage of the passage block and cools the vicinity of the permanent magnet of the core main body block during flowing in the cooling pipe. In the rotary electric machine rotor according to the aspect of the present invention, the passage of the coolant that flows out from the coolant passage of the passage block is ensured by the cooling pipe. Therefore, even when the bond for bonding the permanent magnet to the core main body block flows in a passage direction of the coolant at the time of manufacturing, the passage area inside the cooling pipe is stably maintained.

The core main body block may include a first main body block that is arranged on one side in an axial direction of the passage block and a second main body block that is arranged on another side in the axial direction of the passage block, and the permanent magnet and the cooling pipe may be arranged on each of the first main body block and the second main body block.

In this case, the first main body block is arranged on one side in the axial direction of the passage block, the second main body block is arranged on another side in the axial direction of the passage block, and the vicinity of each of the permanent magnets that are arranged on the main body blocks is cooled by the cooling pipe. Accordingly, when this configuration is employed, it is possible to efficiently cool the first main body block and the second main body block via a single passage block.

The passage block may include: a first plate that is connected to the coolant introduction passage and has an introduction groove; a second plate that is arranged on one side in an axial direction of the first plate and has a communication hole which allows the introduction groove and the cooling pipe on the first main body block side to communicate with each other; and a third plate that is arranged on another side in the axial direction of the first plate and has a communication hole which allows the introduction groove and the cooling pipe on the second main body block side to communicate with each other.

In this case, by forming the introduction groove on the first plate, forming the communication hole on each of the second and third plates, joining the second plate to one side in the axial direction of the first plate, and joining the third plate to another side in the axial direction of the first plate, it is possible to form the passage block.

The passage block may be integrally formed of a plastic material.

In this case, it is possible to easily form the passage block at a further low cost.

The core main body block may include a hollow part as a flux barrier along an axial direction, and the cooling pipe may be arranged on an inner side of the hollow part.

In this case, by using the hollow part as a flux barrier, it is possible to easily arrange the cooling pipe on the core main body block.

A rotary electric machine according to another aspect of the present invention includes: any one of the above rotors; and a stator which is arranged on an outer side in a radial direction of the rotor and around which a coil is wound.

An end part on an opposite side of the passage block of the cooling pipe may be opened at an inner position in a radial direction of the coil.

In this case, when the rotor is rotated, the coolant is injected and supplied to the coil from the opening of the end part of the cooling pipe.

According to an aspect of the present invention, the rotor core includes the core main body block and the passage block, and the cooling pipe that is connected to the coolant passage of the passage block is arranged along the axial direction in the vicinity of the permanent magnet of the core main body block. Therefore, the passage of the coolant is stably ensured by the cooling pipe, and the bond for fixing the permanent magnet to the rotor does not narrow the passage of the coolant at the time of manufacturing. Accordingly, when the aspect of the present invention is employed, it is possible to obtain a stable cooling performance of the rotor.

### BRIEF DESCRIPTION OF THE DRAWINGS

FIG. 1 is a longitudinal cross-section of an upper half part of a rotary electric machine according to an embodiment of the present invention.

FIG. 2 is a cross-sectional view along a II-II line of FIG. 1 of a rotor according to the embodiment of the present invention.

FIG. 3 is an enlarged cross-sectional view of a passage block of the rotor according to the embodiment of the present invention.

FIG. 4 is a front view of a first plate that constitutes the passage block according to the embodiment of the present invention.

FIG. 5 is a front view of second and third plates that constitute the passage block according to the embodiment of the present invention.

FIG. 6 is an enlarged cross-sectional view of a passage block of a rotor according to another embodiment of the present invention.

### DESCRIPTION OF THE EMBODIMENTS

Hereinafter, embodiments of the present invention will be described with reference to the drawings.

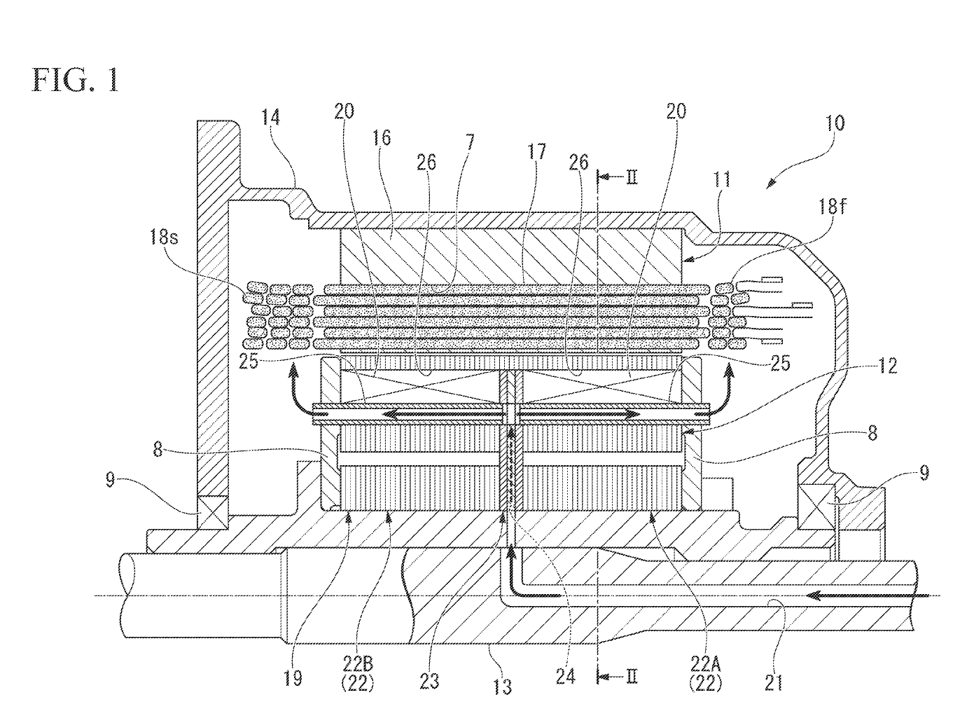

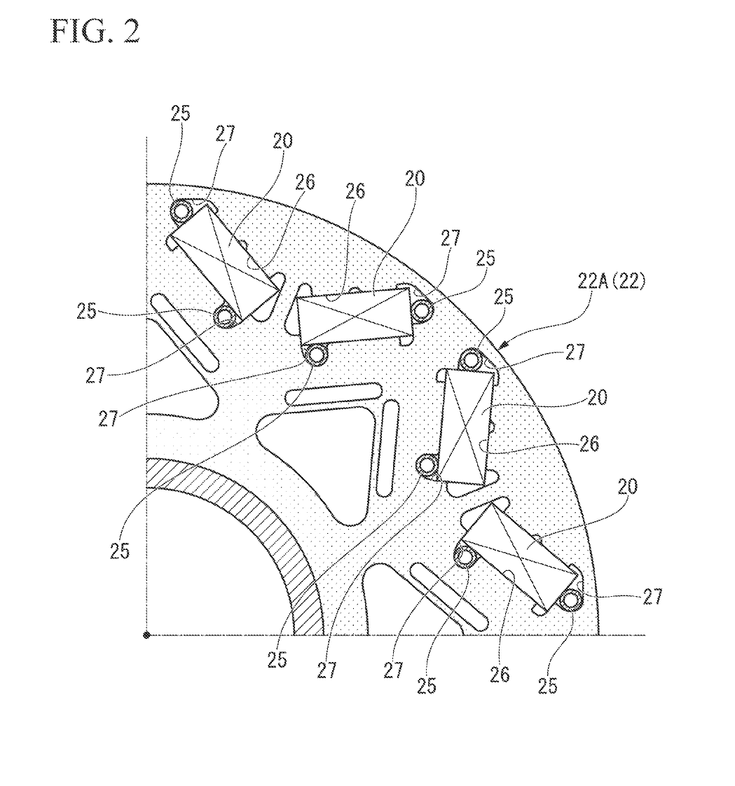

FIG. 1 is a view showing a longitudinal cross-section along an axial direction of an upper half part of a rotary electric machine 10 according to an embodiment. FIG. 2 is a cross-sectional view along a II-II line of FIG. 1. In FIG. 2, only a cross-section of a quarter of a rotor 12 described below is shown.

The rotary electric machine 10 of the present embodiment is used for, for example, a drive source of an electric vehicle. The rotary electric machine 10 includes a stator 11 that generates a rotating magnetic field, a rotor 12 that receives the rotating magnetic field which is generated at the stator 11 and that is rotated, a rotation shaft 13 that is provided concentrically with the rotor 12, and a housing 14 that supports the stator 11 inside the housing 14 and that covers an outside of the stator 11 and the rotor 12.

The stator 11 includes a stator core 16 that is formed by laminating a plurality of electromagnetic steel plates and that has a substantially cylindrical shape and a coil 17 that is wound around an edge part on an inner circumferential side of the stator core 16. The coil 17 is constituted of a three-phase coil of a U-phase, a V-phase, and a W-phase. The coil 17 of the present embodiment is formed of segment coils that have a substantially rectangular cross-section and are used so as to be mutually connected. The segment coil is constituted of a segment conductor which includes a pair of insertion parts that are inserted in a slot 7 of the stator core 16 and a folded connection part that connects together the insertion parts. An end part of the pair of insertion parts on the opposite side of the folded connection part is a connection part that is connected to another adjacent segment conductor.

In the coil 17, the connection part of each segment conductor is arranged on one end side in the axial direction of the stator 11, and the folded connection part is arranged on another end side in the axial direction of the stator 11. The connection part and the folded connection part protrude outward (are exposed to the outside) from each end part in the axial direction of the stator 11. The connection part and the folded connection part constitute coil ends 18f, 18s of the coil 17. An external electric power line is connected to one coil end 18f. A current is distributed to the coil 17 via the electric power line.

The rotor 12 includes a rotor core 19 that is joined integrally to an outer surface of the rotation shaft 13 and a plurality of permanent magnets 20 that are arranged on an outer circumferential edge part of the rotor core 19 so as to be separated from each other in a circumferential direction. The rotor 12 is formed in a substantially cylindrical shape by laminating a plurality of electromagnetic steel plates. The rotation shaft 13 is supported rotatably by the housing 14 via a bearing 9. The rotor 12 receives a rotating magnetic field of the stator 11 and is rotated, and thereby, the rotation shaft 13 is rotated integrally with the rotor 12.

Each of end surface plates 8 in FIG. 1 is overlapped on the electromagnetic steel plate at each of both ends of the rotor 12, and the end surface plates 8 sandwich the plurality of electromagnetic steel plates.

A coolant introduction passage 21 for introducing a coolant to the inside of the rotor 12 is formed on a shaft center part of the rotation shaft 13. The coolant introduction passage 21 is connected to a pump apparatus (not shown). A coolant that is supplied from the pump apparatus is introduced to the coolant introduction passage 21.

The rotor core 19 includes: a core main body block 22 which includes a first main body block 22A and a second main body block 22B; and a passage block 23 that is provided between the first main body block 22A and the second main body block 22B. A plurality of permanent magnets 20 are bonded and fixed to an outer circumferential edge part of the core main body block 22.

The first main body block 22A and the second main body block 22B are formed in a substantially symmetrical shape in an axial direction so as to interpose the passage block 23. The passage block 23 includes a coolant passage 24 of which an inner end in a radial direction is connected to the coolant introduction passage 21 of the rotation shaft 13. Each of end surfaces at both sides of the axial direction of the passage block 23 is in contact with each of the first main body block 22A and the second main body block 22B. An outer end part in the radial direction of the coolant passage 24 is opened to the first main body block 22A side and the second main body block 22B side.

The rotor core 19 further includes a plurality of cooling pipes 25 that are arranged along the axial direction in the vicinity of the permanent magnet 20 of each of the first main body block 22A and the second main body block 22B.

One end side of each of the cooling pipes 25 is connected to the outer end part in the radial direction of the coolant passage 24 of the passage block 23. The other end side of each of the cooling pipes 25 is supported by a corresponding end surface plate 8 in a penetrated state. In this way, the end part of each of the cooling pipes 25 that is supported by the end surface plate 8 is opened at an inner position in the radial direction of each of the coil ends 18f, 18s of the coil 17.

A plurality of attachment holes 26 in each of which a corresponding permanent magnet 20 is fitted is formed on each laminate steel plate of the first main body block 22A and the second main body block 22B. The corresponding permanent magnet 20 is fixed by a bond to each of the attachment holes 26 in a fitted state. A plurality of hollow parts 27 as a flux barrier are formed on each laminate steel plate of the first main body block 22A and the second main body block 22B continuously or adjacent to the attachment hole 26 of the permanent magnet 20. The hollow part 27 is provided along the axial direction on the first main body block 22A and the second main body block 22B. The plurality of cooling pipes 25 described above is arranged to be inserted in each of the hollow parts 27 of the first main body block 22A and the second main body block 22B. In the case of the present embodiment, two cooling pipes 25 are arranged adjacent to one permanent magnet 20.

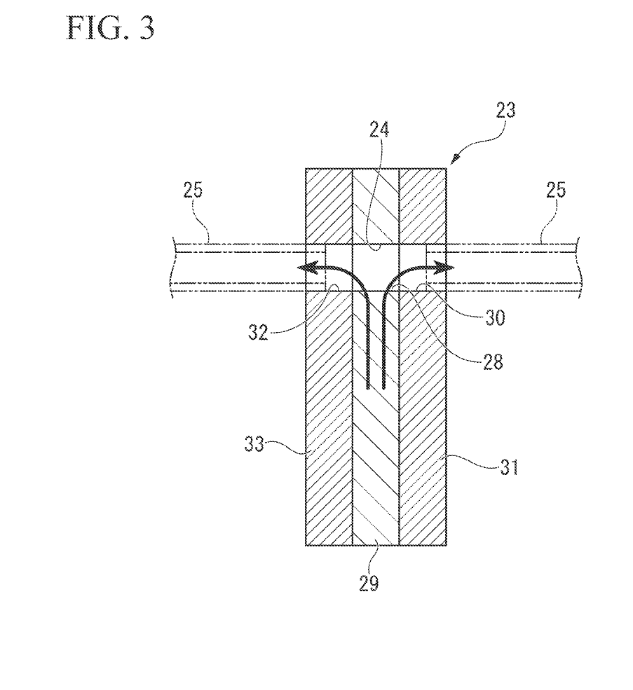

FIG. 3 is an enlarged cross-sectional view of the passage block 23 shown in FIG. 1.

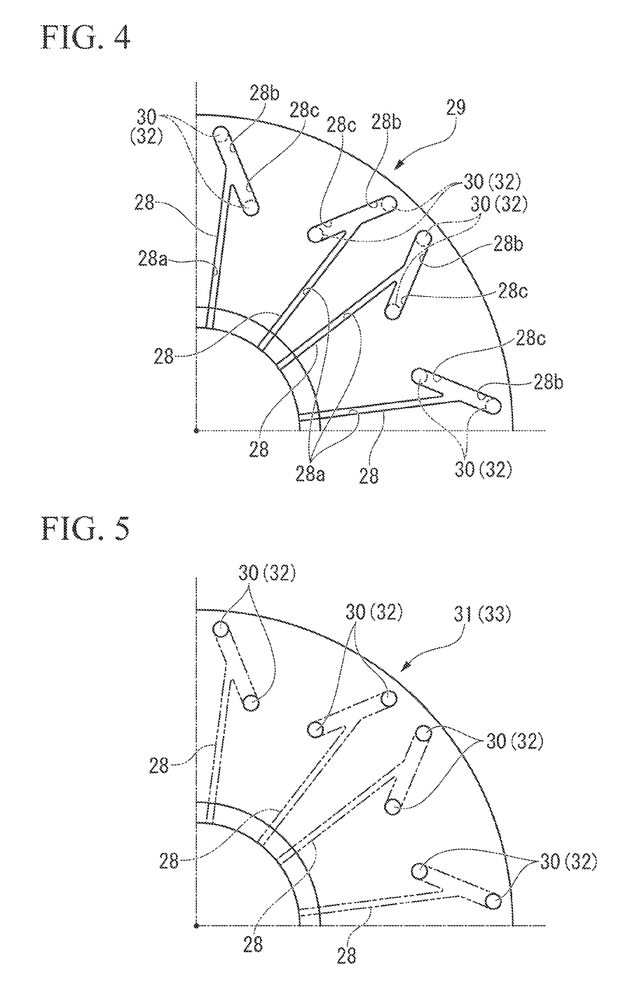

The passage block 23 includes: a first plate 29 that has an introduction groove 28 (refer to FIG. 4) having a slit shape; a second plate 31 that is overlapped on one side in an axial direction of the first plate 29 and has a communication hole 30 which allows the introduction groove 28 of the first plate 29 and the cooling pipe 25 on the first main body block 22A side to communicate with each other; and a third plate 33 that is overlapped on another side in the axial direction of the first plate 29 and has a communication hole 32 which allows the introduction groove 28 of the first plate 29 and the cooling pipe 25 on the second main body block 22B side to communicate with each other. An inner end part in the radial direction of the introduction groove 28 of the first plate 29 is connected to the coolant introduction passage 21 of the rotation shaft 13. The introduction groove 28 of the first plate 29, the communication hole 30 of the second plate 31, and the communication hole 32 of the third plate 33 constitute the coolant passage 24 of the passage block 23.

FIG. 4 is a front view of part of the first plate 29. FIG. 5 is a front view of part of the second plate 31 and the third plate 33.

In the case of the present embodiment, a radial direction groove 28a that extends outward in the radial direction from an inner end part in the radial direction of the first plate 29 and branch passages 28b, 28c that branch in two directions from an outer end part in the radial direction of the radial direction groove 28a are formed on the introduction groove 28 of the first plate 29. The communication hole 30 of the second plate 31 and the communication hole 32 of the third plate 33 are formed at a position that is overlapped with the branch passages 28b, 28c of the first plate 29. When the second plate 31 is joined to the first plate 29, the communication hole 30 is connected to the corresponding branch passages 28b, 28c. When the third plate 33 is joined to the first plate 29, the communication hole 32 is connected to the corresponding branch passages 28b, 28c.

A corresponding cooling pipe 25 is fitted into and fixed to the communication hole 30 of the second plate 31 and the communication hole 32 of the third plate 33.

When actually manufacturing the rotor 12, in the first and second main body blocks 22A, 22B, steel plates are laminated in advance, and the permanent magnet 20 and the cooling pipe 25 are assembled to the laminate steel plate. At this time, the end part of the cooling pipe 25 is sealed by a seal stopple (not shown), and in that state, the permanent magnet 20 is fixed to the laminate steel plate by a bond. The seal stopple is removed after the permanent magnet 20 is bonded and fixed. Then, each of the first main body block 22A and the second main body block 22B is joined to each of end surfaces of the passage block 23. At this time, the end part of each cooling pipe 25 is fitted in corresponding one of the communication holes 30, 32 of the passage block 23. When the rotor 12 is manufactured in this way, it is possible to prevent the bond for fixing the permanent magnet 20 from flowing in the inside of the coolant passage 24 and the cooling pipe 25.

In the rotary electric machine 10 of the present embodiment, when the coolant is introduced to the coolant introduction passage 21 of the rotation shaft 13 at the time of the rotation of the rotor 12, the coolant is introduced to the plurality of cooling pipes 25 via the coolant passage 24 of the passage block 23 of the rotor core 19. When the coolant is introduced to each of the cooling pipes 25 in this way, the coolant passes through the inside of each of the cooling pipes 25, cools a part close to each permanent magnet 20 of the first main body block 22A and the second main body block 22B, and then flows out to the outside from the end part of each cooling pipe 25. At this time, the coolant that flows out to the outside is injected and supplied to each of the coil ends 18f, 18s of the coil 17 by a centrifugal force of the rotor 12. As a result, the part close to the permanent magnet 20 of the rotor 12 and each of the coil ends 18f, 18s of the coil 17 are cooled by the coolant.

As described above, in the rotor 12 of the rotary electric machine 10 of the present embodiment, the rotor core 19 includes the core main body block 22 and the passage block 23, and the cooling pipe 25 that is connected to the coolant passage 24 of the passage block 23 is arranged along the axial direction in the vicinity of the permanent magnet 20 of the core main body block 22. Therefore, the passage of the coolant inside the rotor 12 is stably ensured by the cooling pipe 25, and the bond for fixing the permanent magnet 20 does not narrow the passage of the coolant at the time of manufacturing. Accordingly, when the rotor 12 of the present embodiment is employed, it is possible to obtain a stable cooling performance of the rotor 12.

Further, in the rotor 12 of the present embodiment, the core main body block 22 includes the first main body block 22A that is arranged on one side in the axial direction of the passage block 23 and the second main body block 22B that is arranged on another side in the axial direction of the passage block 23, and the permanent magnet 20 and the cooling pipe 25 are arranged on each of the first main body block 22A and the second main body block 22B. Therefore, when the rotor 12 of the present embodiment is employed, it is possible to efficiently cool the vicinity of the permanent magnet 20 of the first main body block 22A and the second main body block 22B via the single passage block 23 by the coolant.

Further, in the rotor 12 of the present embodiment, the passage block 23 includes the first plate 29, the second plate 31, and the third plate 33, and the introduction groove 28 that is connected to the coolant introduction passage 21 is provided on the first plate 29. The communication hole 30 which allows the introduction groove 28 and the cooling pipe 25 on the first main body block 22A side to communicate with each other is provided on the second plate 31, and the communication hole 32 which allows the introduction groove 28 and the cooling pipe 25 on the second main body block 22B side to communicate with each other is provided on the third plate 33. Accordingly, when this configuration is employed, by forming the introduction groove 28 on the first plate 29, forming the communication hole 30 on the second plate 31, forming the communication hole 32 on the third plate 33, joining the second plate 31 to one side in the axial direction of the first plate 29, and joining the third plate 33 to another side in the axial direction of the first plate 29, it is possible to easily form the passage block 23.

Further, in the rotor 12 of the present embodiment, the hollow part 27 as a flux barrier along the axial direction is provided on the core main body block 22, and the cooling pipe 25 is arranged on the inner side of the hollow part 27. Therefore, in the rotor 12 of the present embodiment, by using the hollow part 27 as a flux barrier, it is possible to easily arrange the cooling pipe 25 in the vicinity of the permanent magnet 20 of the core main body block 22.

Further, in the rotary electric machine 10 of the present embodiment, the end part on the opposite side of the passage block 23 of the cooling pipe 25 is opened at an inner position in the radial direction of the coil 17 of the stator core 16. Therefore, at the time of the rotation of the rotor 12, it is possible to efficiently cool the coil 17 by the coolant that is injected from the cooling pipe 25. Particularly, when the coolant flows inside the cooling pipe 25, the coolant does not leak to the outside, and therefore, it is possible to efficiently inject and supply the coolant to the coil 17.

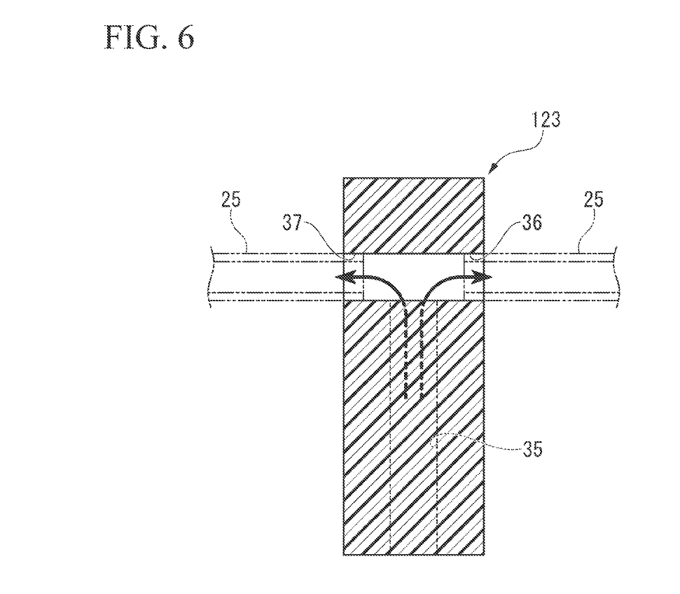

FIG. 6 is an enlarged cross-sectional view showing a passage block 123 of a rotor according to another embodiment.

The passage block 23 of the embodiment described above has a configuration in which the second plate and the third plate are overlapped with the first plate; however, the entire passage block 123 of the present embodiment is integrally formed of a plastic material. That is, in the passage block 123 of the present embodiment, an introduction hole 35 that is connected to a coolant introduction passage of a rotation shaft, a communication hole 36 that allows the introduction hole 35 to communicate with the cooling pipe 25 on the first main body block side, and a communication hole 37 that allows the introduction hole 35 to communicate with the cooling pipe 25 on the second main body block side are formed on a plastic block.

When the rotor of the present embodiment is employed, it is possible to easily form the passage block 123 at a further low cost.

The present invention is not limited to the embodiments described above, and a variety of design changes can be made without departing from the scope of the invention. For example, in the embodiments described above, an example of a segment coil having a substantially rectangular cross-section is shown as the coil 17; however, a round wire or a bundle wire can be also used.

What is claimed is:

1. A rotary electric machine rotor that is a rotor of a rotary electric machine which comprises:
a rotor core that is fixed to a rotation shaft and that is rotated integrally with the rotation shaft; and
a permanent magnet that is bonded and fixed to the rotor core,
wherein a coolant that is introduced from a coolant introduction passage of the rotation shaft flows in a vicinity of the permanent magnet of the rotor core and cools the rotor core,
wherein the rotor core comprises:
a core main body block to which the permanent magnet is bonded and fixed;
a passage block that has a coolant passage which is connected to the coolant introduction passage of the rotation shaft and that is joined to an end part in an axial direction of the core main body block; and
a cooling pipe that is connected to the coolant passage of the passage block and that is arranged along an axial direction in a vicinity of the permanent magnet of the core main body block.

2. The rotary electric machine rotor according to claim 1,
wherein the core main body block comprises a first main body block that is arranged on one side in an axial direction of the passage block and a second main body block that is arranged on another side in the axial direction of the passage block, and
the permanent magnet and the cooling pipe are arranged on each of the first main body block and the second main body block.

3. The rotary electric machine rotor according to claim 2,
wherein the passage block comprises:
a first plate that is connected to the coolant introduction passage and has an introduction groove;
a second plate that is arranged on one side in an axial direction of the first plate and has a communication hole which allows the introduction groove and the cooling pipe on the first main body block side to communicate with each other; and
a third plate that is arranged on another side in the axial direction of the first plate and has a communication hole which allows the introduction groove and the cooling pipe on the second main body block side to communicate with each other.

4. The rotary electric machine rotor according to claim 1,
wherein the passage block is integrally formed of a plastic material.

5. The rotary electric machine rotor according to claim 1,
wherein the core main body block comprises a hollow part as a flux barrier along an axial direction, and
the cooling pipe is arranged on an inner side of the hollow part.

6. A rotary electric machine, comprising:
a rotary electric machine rotor according to claim 1; and
a stator which is arranged on an outer side in a radial direction of the rotor and around which a coil is wound.

7. The rotary electric machine according to claim 6,
wherein an end part on an opposite side of the passage block of the cooling pipe is opened at an inner position in a radial direction of the coil.
